(19) United States
(12) Patent Application Publication
(10) Pub. No.: US 2006/0115275 A1
(43) Pub. Date: Jun. 1, 2006

(54) Multiple rate optical transponder

(76) Inventors: Jiaxi Kan, San Jose, CA (US); Zhigang Gong, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/001,429

(22) Filed: Dec. 1, 2004

(51) Int. Cl. H04B 10/00

(52) U.S. Cl. 398/135

(57) ABSTRACT

A transponder is disclosed. This transponder includes a transceiver to transmit and receive optical input/output (I/O). In addition, the transponder includes a first clock source and a second clock source. The first clock source operates the transceiver at a first data rate upon receiving a select signal indicating that the transceiver is to operate at the first date rate. The second clock source operates the transceiver at a second data rate upon receiving a select signal indicating that the transceiver is to operate at the second date rate.

### FIELD OF THE INVENTION

The present invention relates to fiber optic communication; more particularly, the present invention relates to optical transceivers.

### BACKGROUND

Optical transceivers (or transponders) operating at line rates of ten (10 Gb/s) have developed rapidly over the past few years. These transponders are currently available in a wide variety of form factors, such as Xenpak and X2, which are low cost and scalable. An advantage of choosing a standard form factor transponder is to have the choice of selecting between multiple suppliers. Another advantage is to apply the same line card design to target different applications while hiding the transponder technology difference away from end users.

From a customers' point of view, it is desirable to have one transponder capable of operating for several different applications rather than having to use different transponders for multiple applications. An ideal situation would be to have one transponder work in several close but different line rates. However, conventional transponder designs can operate at only one fixed data rate from one module (e.g., SONET (9.953 Gb/s), 10 G Ethernet (10.3 Gb/s), or 10 G Fiber Channel (10.5 Gb/s), etc.). Such limitation gives costumer less flexibility procuring parts and causes higher inventory costs.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a line card;

FIG. 2 illustrates a block diagram of one embodiment of a transponder;

FIG. 3 illustrates a block diagram of another embodiment of a transponder; and

FIG. 4 illustrates a top view of one embodiment of a transponder circuit board.

### DETAILED DESCRIPTION

According to one embodiment, a multiple rate optical transponder is disclosed. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

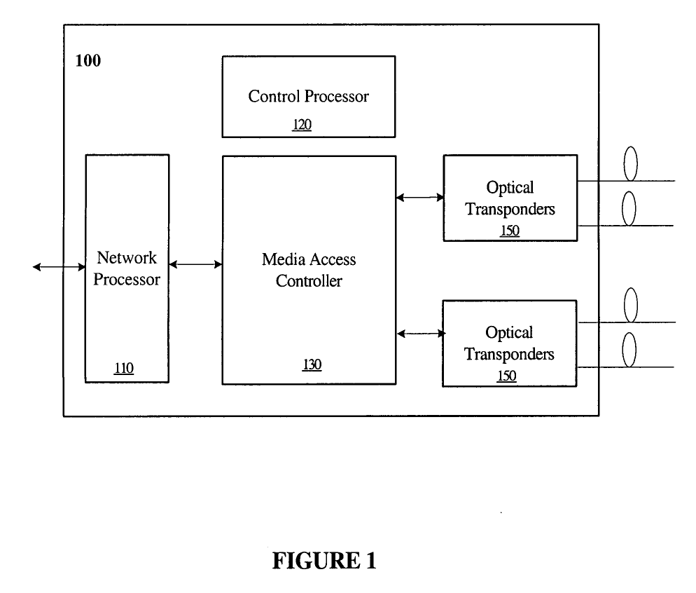

FIG. 1 is a block diagram of one embodiment of a line card 100. Line card 100 is an input/output (I/O) card that may be inserted in a modular chassis, such as a blade server, network switch, or router. Line card 100 includes a network processor 110, control processor 120, media access controller (MAC) 130, and one or more optical transponders 150.

Network processor 110 processes data packets. In particular, processor 110 receives packets from a switch fabric device (not shown), processes the packets and forwards the packets to another network (e.g., an optical network) based upon control information received from control processor 120. Further, processor 110 receives data from an optical network and forwards the data to the switch fabric device. Control processor 120 processes control information, such as control commands.

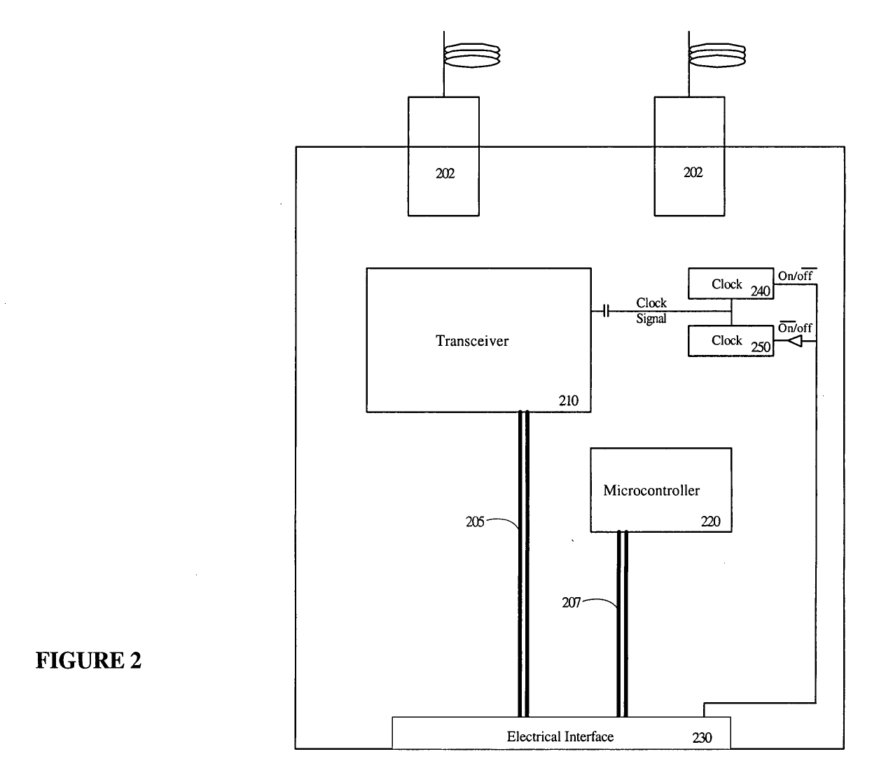

MAC 130 controls media access of transmitting and receiving packets to and from line card 100. Transponder 150 transmits and receives optical data. FIG. 2 illustrates a block diagram of one embodiment of transponder 150. Transponder 150 includes optical interfaces 202, transceiver 210, microcontroller 220, electrical interface 230, and clocks 240 and 250.

Optical interfaces 202 are coupled to optical fibers, and are implemented to transmit optical data from transponder 150 via the fibers, as well as to receive optical data from the fibers. Transceiver 210 includes a receiver component and a transmitter component used to transmit/receive optical data. The receiver component includes active components that are implemented to receive optical data from one or more optical fibers.

The active components convert a received optical input signal into an electrical signal that is forwarded to MAC 130. The transmitter component receives electrical signals and converts the signals to optical output signals that are transmitted via the optical fibers.

According to one embodiment, transceiver 210 is coupled to electrical interface 230 via a management data interface (MDIO) 205.

Microcontroller 220 is implemented to operate control systems that set control parameters for transceiver 210. In one embodiment, the control parameters may vary over time and temperature. In a further embodiment, microcontroller 220 also provides a two-wire interface 207 (e.g., I²C) so that control parameters can be set and status registers can be read from card 100 where monitor values are stored.

Electrical interface 230 provides I/O data transfer to card 100. In addition, interface 230 provides various clocking channels, control and monitoring channels, as well as DC power and ground connections. According to one embodiment, interface 230 is a seventy (70) pin connector that plugs perpendicularly into the plane of card 100. However, in other embodiments, interface 230 may be implemented as other types of connectors, or can take the form of a board-edge connection that mate to a socket in the plane of the card 100.

Clocks 240 and 250 are clocks that provide the reference clock to transceiver 210 for transmitting and receiving data at transponder 150. According to one embodiment, clocks 240 and 250 enable transponder 150 to operate at two or more data rates while maintaining high optical and electrical output quality at each data rate transponder 150 operates. For instance, clock 240 may provide a first data rate, while clock 250 provides a second data rate.

According to one embodiment, clock 240 operates according to a data rate designed for SONET operation (e.g., 9.953 Gb/s), while clock 250 operates at a data rate implemented in 10 G Ethernet (e.g., 10.3 Gb/s) designs. However, in other embodiments, it is apparent that either clock 240 or 250 may implant other data rates, such as 10.5 Gb/s for 10 G Fiber Channel designs.

In one embodiment, a clock selection line is coupled to both clocks 240 and 250 to transmit a select signal to clocks 240 and 250. The select signal indicates which clock is to provide the data rate for transponder 150. An inverter is coupled to the input of clock 250 to invert the select signal. Thus, when the select signal is a high logic value (e.g., logic 1) clock 250 is de-activated, while clock 240 provides the data rate. Conversely, if the select signal is a low logic value (e.g., logic 0) clock 250 is the active clock, while clock 240 is de-activated.

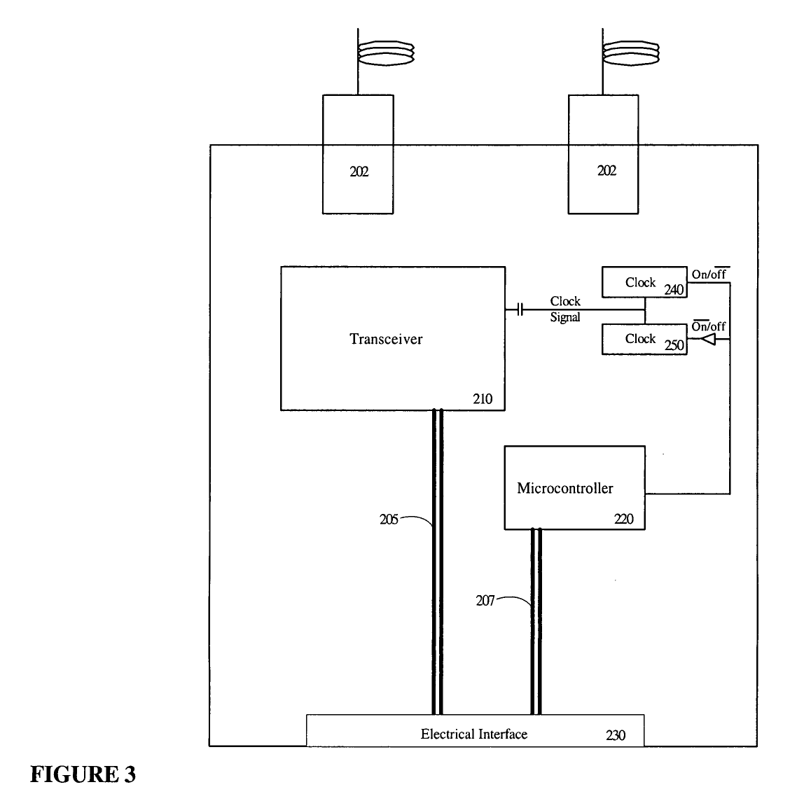

According to one embodiment, the select signal is generated via hardware. In such an embodiment, the select signal value is selected by controlling the input voltage on a vendor specific pin from electrical interface 230. FIG. 3 illustrates a block diagram of another embodiment of transponder 150 where the select signal is generated via software. In this embodiment, the select signal value is selected by switching a control register bit on line card 100. The selection is then transmitted to microcontroller via the I²C interface. Microcontroller 220 is coupled to the select line and transmits the select signal to clocks 240 and 250.

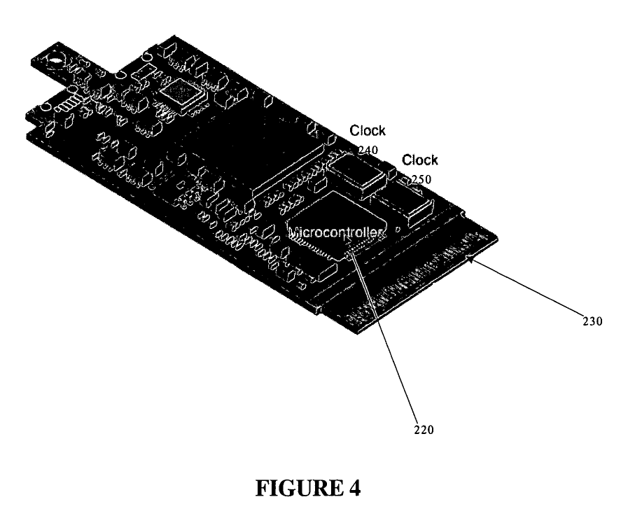

According to one embodiment, software control enables an end user to make a temporary choice in data rate. In such an embodiment, the data rate may switch back to the original selection after a power cycle. Note that in other embodiments, that the embodiments of FIG. 3 and FIG. 4 may be combined to enable both software and hardware selection in the same transponder 150.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

What is claimed is:

1. A transponder comprising:
a transceiver to transmit and receive optical input/output (I/O);
a first clock source to operate the transceiver at a first data rate upon receiving a select signal indicating that the transceiver is to operate at the first date rate; and
a second clock source to operate the transceiver at a second data rate upon receiving a select signal indicating that the transceiver is to operate at the second date rate.

2. The transponder of claim 1 further comprising a microcontroller to operate control systems for the transceiver.

3. The transponder of claim 2 further comprising an electrical interface to transfer I/O from the transponder.

4. The transponder of claim 3 wherein the electrical interface provides clocking channels.

5. The transponder of claim 3 wherein the electrical interface is a seventy (70) pin connector.

6. The transponder of claim 3 further comprising a first interface coupled between the transceiver and the electrical interface.

7. The transponder of claim 6 wherein the first interface is a management data interface (MDIO).

8. The transponder of claim 6 further comprising a second interface coupled between the microcontroller and the electrical interface.

9. The transponder of claim 8 wherein the first interface is a two wire interface.

10. The transponder of claim 9 wherein the two wire interface is an inter-integrated circuit (I²C) interface.

11. The transponder of claim 4 wherein the select signal value is controlled by controlling input voltage on the electrical interface.

12. The transponder of claim 4 wherein the select signal value is controlled by receiving the select signal value at the microcontroller and transmitting the value to the first clock source and the second clock source.

13. A method comprising:
selecting a signal value indicating whether a transponder is to operate according to a first date rate or a second data rate;
transmitting the signal value to a first clock designated to operate the transponder at the first date rate; and
transmitting the signal value to a second clock designated to operate the transponder at the second date rate.

14. The method of claim 13 further comprising activating the first clock if the signal value indicates that the transponder is to operate at the first data rate.

15. The method of claim 13 further comprising activating the second clock if the signal value indicates that the transponder is to operate at the second data rate.

16. The method of claim 13 wherein selecting the signal value comprises controlling input voltage at an electrical interface.

17. The method of claim 13 wherein selecting the signal value comprises switching a register bit.

18. A line card comprising:
a media access controller (MAC); and
an optical transponder, coupled to the MAC, having:
a first clock source to operate the transponder at a first data rate upon receiving a select signal indicating that the transponder is to operate at the first date rate; and
a second clock source to operate the transponder at a second data rate upon receiving a select signal indicating that the transponder is to operate at the second date rate.

19. The line card of claim 18 wherein the transponder further comprises a transceiver to transmit and receive optical input/output (I/O);

20. The line card of claim 19 further comprising a microcontroller to operate control systems for the transceiver.

21. The line card of claim 20 further comprising an electrical interface to transfer I/O between the transponder and the MAC.

22. The line card of claim 21 wherein the select signal value is controlled by controlling input voltage on the electrical interface.

23. The line card of claim 21 wherein the select signal value is controlled by receiving the select signal value at the microcontroller and transmitting the value to the first clock source and the second clock source.

24. The line card of claim 18 further comprising:
a network processor coupled to the MAC; and
a control processor coupled to the MAC.
